(19) United States
(12) Patent Application Publication
(10) Pub. No.: US 2008/0245357 A1
(43) Pub. Date: Oct. 9, 2008

(54) OUTDOOR GRILL WITH INTERCHANGEABLE MODULAR COOKING ASSEMBLIES

(75) Inventors: Stuart L. Meether, Wichita, KS (US); David C. Thornhill, Mooresville, NC (US); Paul A. Grimes, Wichita, KS (US); Robert F. Mosher, Wichita, KS (US)

Correspondence Address: Kelly S.K. Elsea;Intellectual Property Counsel for The Coleman, Company, Inc., 3600 N. Hydraulic, Wichita, KS, 67219, US

(73) Assignee: The Coleman Company, Wichita, KS (US)

(21) Appl. No.: 12/137,794

(22) Filed: Jun. 12, 2008

(30) Foreign Application Priority Data
Dec. 18, 2006 (US) PCT/US2006/062248

(51) Int. Cl. A47J 37/00

(52) U.S. Cl. 126/25 R

(57) ABSTRACT

An outdoor grill (20) having interchangeable cooking accessories (60, 70, 80, 90, 100). As examples, the cooking accessories may include a hot dog cooker (70), a steamer, a food preparation assembly (60), a side burner, a griddle (80), a deep fryer (90), a rotisserie (100), or other cooking accessories. At least some of the cooking accessories may be sold separately from the grill (20), permitting a user to upgrade accessories when desired, or when cost constraints permit. A single grill frame and firebox (22) may be sold in the same store with different cooking accessories. Alternatively, the grill (20) may be sold in one store with a particular cooking accessory or accessories, and in another store with a different accessory. Some combinations may be sold only at particular stores, allowing a manufacturer to market specific grill combinations to a particular chain or store, and thus channel differentiation.

### CROSS-REFERENCE TO RELATED APPLICATIONS

This patent application claims the benefit of PCT/US2006/062248 filed Dec. 18, 2006, which claims the benefit of U.S. Provisional Patent Application No. 60/751,262, filed Dec. 16, 2005, both of which are incorporated herein by reference.

### TECHNICAL FIELD OF THE INVENTION

The present is directed to grills, and more specifically outdoor grills for use in backyard cooking, for example.

### BACKGROUND OF THE INVENTION

Outdoor grilling is a popular way to cook foods, especially in warmer weather. Conventional grills utilize charcoal or wood, or may use liquid fuels, such as gas or propane. Most large outdoor grills that are used for backyard cooking include a firebox mounted about waist high on a frame. The frame typically includes wheels so that the grill may be rolled to a convenient location in the yard.

Conventional outdoor grills come in a variety of sizes and shapes, with various accessories. One problem with conventional grills is that a purchaser may have to make a decision between quality and accessories due to price constraints. As an example, a potential purchaser may want to buy a high quality grill, but cannot afford such a grill with all the accessories that the purchaser would like. The potential purchaser must make a decision between purchasing a high quality grill without accessories, or a lower quality grill that has the accessories that he or she desires.

In addition to the above, many grill users desire that their grills be capable of additional functions. The increase in outdoor cooking over the last few years has resulted in many users desiring that their grills serve many of the functions that are available in their kitchens. However, in reality, most outdoor grillers utilize the cook box of a grill for cooking a main course for a meal, and then run back and forth between a grill and an indoor kitchen for other cooking needs.

### SUMMARY OF THE INVENTION

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

In accordance with an embodiment, an outdoor grill is provided that has interchangeable, attachable modular accessories. As examples, the modular accessories may include a hot dog cooker, a steamer, a food preparation assembly, a side burner, a griddle, a deep fryer, a rotisserie, or other cooking accessories. Alternatively or additionally, the modular accessories may be accessories that are not used for cooking, including, but not limited to, an insulated container for beverages or food, or a light for illuminating the grill.

In accordance with an embodiment, at least some of the cooking accessories are sold separately from the grill, permitting a user to upgrade accessories when desired, or when the user's budget permits. By selling the cooking accessories separate from the grill, a potential purchaser may buy a high quality grill and then add accessories at a later point, permitting the total cost of the grill and accessories to be spread out over time, and allowing the purchaser to purchase the level of quality he or she desires.

In accordance with an embodiment, a grill in accordance with the invention permits a single grill frame and firebox to be sold in the same store with different cooking accessories. In this manner, the grill may be sold at various price points in the same store, and/or a purchaser may purchase a grill with exactly the desired accessory or accessories. Alternatively, the grill may be sold in one store with a particular cooking accessory or accessories, and in another store with a different accessory. Some combinations may be sold only at particular stores, allowing a manufacturer to market specific grill combinations to a particular chain or store, and thus permitting channel differentiation.

Other features of the invention will become apparent from the following detailed description when taken in conjunction with the drawings, in which:

### BRIEF DESCRIPTION OF THE DRAWINGS

FIG. 1 is side perspective view of a grill in accordance with an embodiment of the invention;

FIG. 2 is a top perspective view of the grill of FIG. 1;

FIG. 3 is an exploded side perspective view of a food preparation assembly that may be utilized as a cooking accessory for the grill of FIG. 1 in accordance with an embodiment of the invention;

FIG. 4 is a side perspective view of a side burner accessory that may be utilized as a cooking accessory for the grill of FIG. 1 in accordance with an embodiment;

FIG. 5 is a side perspective view of a griddle assembly that may be utilized as a cooking accessory for the grill of FIG. 1 in accordance with an embodiment;

FIG. 6 is a side perspective view of a deep fryer assembly that may be utilized as a cooking accessory for the grill of FIG. 1 in accordance with an embodiment;

FIG. 7 is a side perspective view of a rotisserie assembly that may be utilized as a cooking accessory for the grill of FIG. 1 in accordance with an embodiment;

FIG. 8 is an exploded view showing a gas connection assembly that may be used in accordance with an embodiment;

FIG. 9 is a front perspective view of an alternate embodiment of a grill in accordance with an embodiment;

FIG. 10 is a front perspective view of a grill with interchangeable cooking accessories in accordance with an embodiment;

FIG. 11 is an exploded perspective view of an alternate embodiment of a grill with interchangeable cooking accessories; and

FIG. 12 is a side view of the firebox and stand for the grill in FIG. 11.

### DETAILED DESCRIPTION

In the following description, various embodiments of the present invention will be described. For purposes of explanation, specific configurations and details are set forth in order to provide a thorough understanding of the embodiments. However, it will also be apparent to one skilled in the art that the present invention may be practiced without the specific details. Furthermore, well-known features may be omitted or simplified in order not to obscure the embodiment being described.

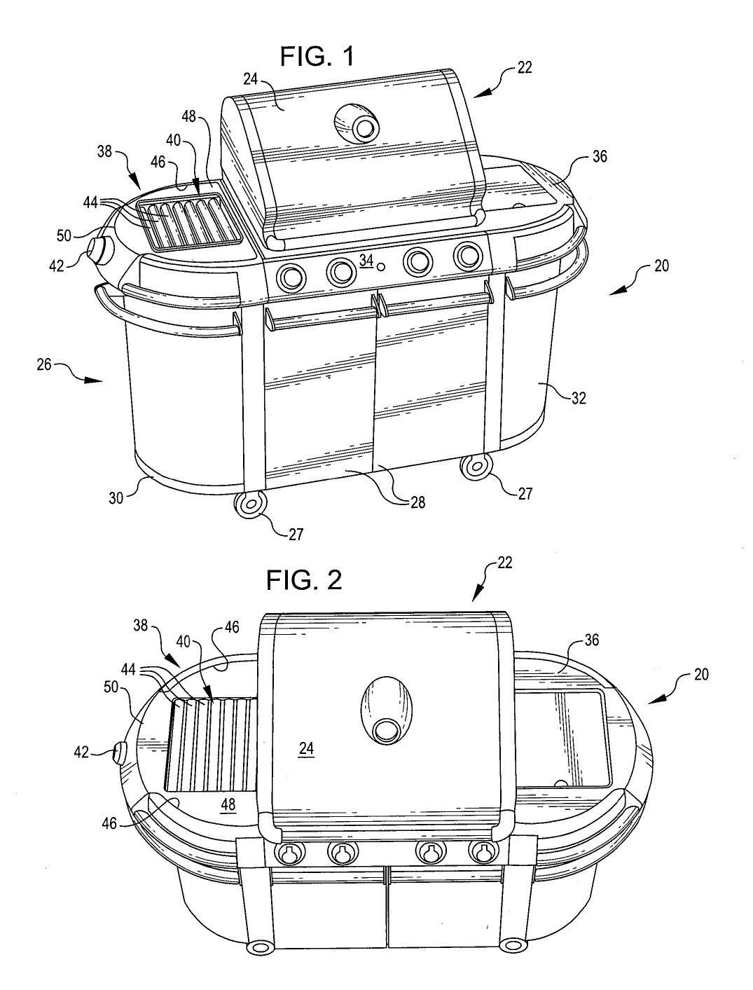

Referring now to the drawings, in which like reference numerals represent like parts throughout the several views, FIG. 1 shows a grill 20 in accordance with an embodiment of the invention. The grill 20 includes a firebox 22 having a lid 24. The firebox 22 is mounted on a stand 26 having wheels 27.

In the embodiment shown in the drawing, the stand 26 includes center doors 28, and rounded side doors 30, 32. A control panel 34 is mounted above the center doors 28. A right side table 36 is mounted above the right side door 32, and a left side table 38 is mounted above the left side door 30.

In accordance with an embodiment, the present invention provides modular, interchangeable accessories that may be attached to and used in connection with a grill, such as the grill 20. By a “cooking accessory,” or a “modular accessory,” we mean any item that may be removably attached to and used while an individual is cooking using the grill or in connection with the grill. The accessories do not necessarily have to be used in connection with the cooking. For example, as described below, one of the accessories may be an insulated container for holding beverages. As another example, a modular accessory might be a light for illuminating the grill.

The accessories may be attached anywhere on the grill, including directly to the firebox 22 or to the stand 26. To this end, as used herein, “stand” is meant to include any part of the grill that is not the firebox.

In the embodiment shown in the drawings, the interchangeable cooking accessories are removably attached to the left side table 38. However, in alternate embodiments, the interchangeable cooking accessories may be positioned on either of the side tables 36, 38, on a front of the grill 20, on a rear portion of the grill, underneath or over the firebox 22, may be mounted inside the firebox, or any combination of these. However, by placing the interchangeable cooking accessories on one of the side tables 36, 38, the accessories are readily available and are out of the way of a user that is cooking using the firebox 22.

In the embodiment shown in FIG. 1, the interchangeable cooking accessory is a hot dog cooker 40. The hot dog cooker 40 includes a control knob 41 for controlling heat to a burner (not shown) for the cooker, and a plurality of rotating cylinders 44. The burner is used to heat a bottom side of the rotating cylinders 44.

Although not shown in the drawings, propane, gas, or other fuel that is utilized by the grill 20 is supplied to the burner for the hot dog cooker 40. The propane or other gas that is supplied to the hot dog cooker 40 may be supplied, for example, via a conduit that connects directly to the main manifold for the gas system for the grill 20. As is further described below, the hot dog cooker 40 is connected and disconnected to this fuel supply during installation and removal of the hot dog cooker 40, respectively. Example connections are described below.

The rotating cylinders 44 may be driven by batteries or AC power. In an embodiment, the rotating cylinders 44 are connected to a rotisserie motor (not shown) and are driven by that motor. The rotisserie motor may have a special connection that connects, for example, to a gear for the rotating cylinders 44 when the hotdog cooker is in place. If a separate motor is used for the hot dog cooker, power for the separate motor may also be supplied by a quick connect or other releasably connectable electrical connection.

During use, hotdogs are placed on the rotating cylinders 44, and the cylinders 44 rotate while heat is supplied to the cylinders via a fire in the burner. The continual rotation of the cylinders ensures that the hot dogs are cooked uniformly.

In the embodiment shown in the drawings, the modular accessories are mounted in an inset 46 in the left side table 38. The inset 46 includes a wide end 48 adjacent to the firebox 22 and a narrowed portion 50 on the distal side of the left side table 38. The narrowed portion 50 extends downward to include the bottom and outer extremities of the left side table 38.

In an embodiment, the modular accessories may be shaped so that they are slightly tapered and are held by gravity into the inset 46. Alternatively or additionally, fasteners, snaps, or other features may be used to position the modular accessories in place. In addition, if desired, different arrangements may be used for receiving the modular accessories. In an embodiment, a left side table 38 or other structure may not be provided, and the modular accessories may bolt or otherwise connect directly to the firebox 22 or the stand 26.

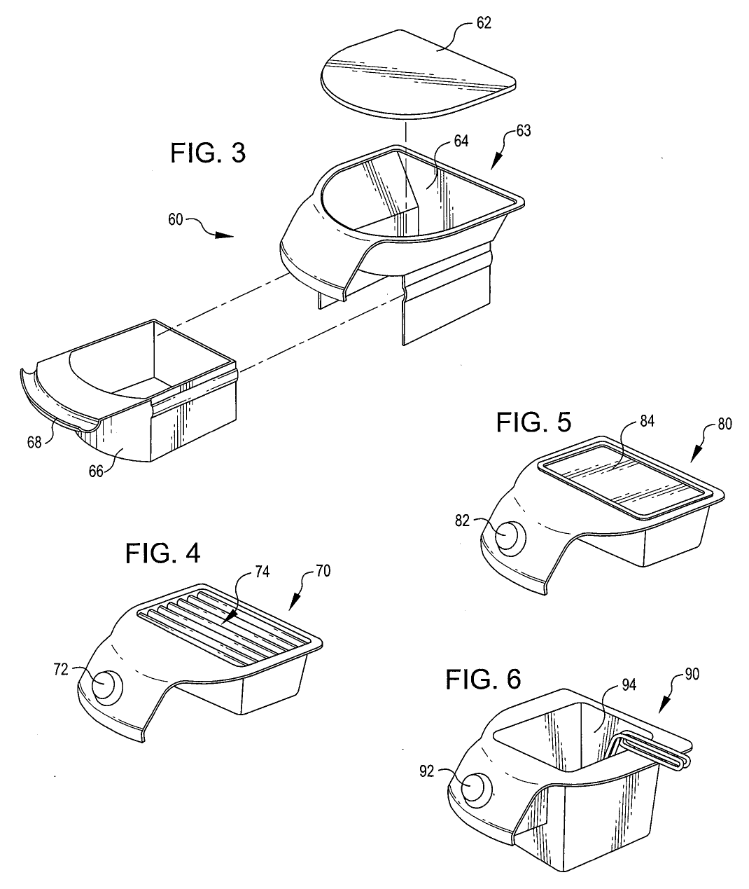

FIG. 3 shows a food preparation assembly 60 that may be mounted in the inset 46. The food preparation assembly 60 includes a cutting board 62 that fits on top of a basin 63. The basin 63 includes tapered side walls 64 that lead down to a drawer 66. The drawer 66 may be insulated and may hold, for example, food or other items that are later to be placed on the grill 20. In addition, if desired, the drawer 66 may be used for storage of beverages. The drawer 66 includes a handle 68 for easy removal. The side walls 64 are sloped so that they act as a hopper to direct beverages or other items down into the drawer.

As can be seen, the food preparation assembly 60 does not include a propane burner and thus does not need a connection to propane or electricity. Thus, this modular accessory is a low end modular accessory, and may be provided, for example, with the grill 20 at a lower price than a grill provided with a more complex modular accessory (e.g., the hotdog cooker 40). As an alternative to the food preparation assembly 60, an insulated container may be provided that fits in the inset 46 and that serves as a beverage cooler. Other alternatives include, but are not limited to, a storage drawer, a refrigerator, a mini-keg cooler, or an extended table.

FIG. 4 shows a side burner assembly 70 that may be used as one of the modular assemblies in accordance with an embodiment. The side burner assembly 70, like the hot dog cooker assembly 40, includes a control knob 72. In addition, the side burner 70 includes a cooking surface 74, under which is mounted a burner (not shown). The side burner assembly 70 includes a connection (not shown) to the propane manifold as described with the hot dog cooker 40.

FIG. 5 shows a griddle assembly 80 that may be used as one of the modular accessories in accordance with an embodiment. The griddle assembly 80 is similar to the side burner assembly 70, in that it includes a control knob 82 and a burner for supplying heat. However, instead of the cooking surface 74, the griddle assembly 80 includes a griddle surface 84 for cooking. As an example of another accessory, a skillet may be provided.

FIG. 6 shows a deep fryer assembly 90 that may be used as one of the modular accessories in accordance with an embodiment. The deep fryer assembly includes a control knob 92 for controlling fuel to a burner (not shown). The deep fryer assembly 90 also includes a fryer basin 94 into which oil may be placed for the frying of foodstuffs, such as French fries. A similar structure to the deep fryer assembly 90 may be utilized as a steamer. In either event, as with the hot dog cooker 40, the deep fryer assembly includes a connection to propane or other gas for the burner.

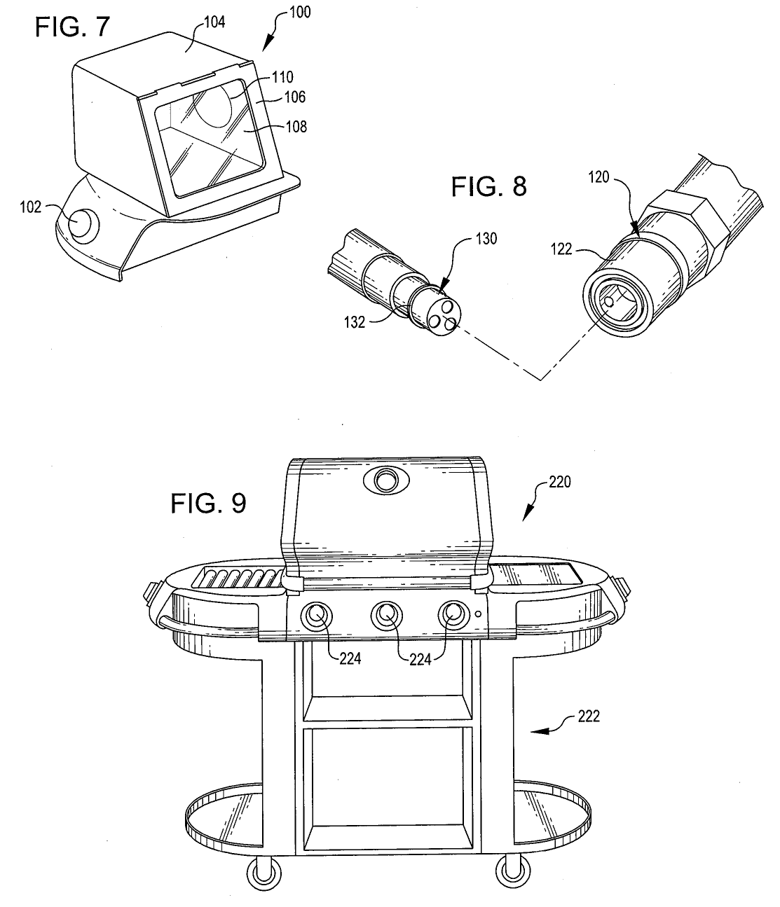

FIG. 7 shows a rotisserie assembly 100 that may be used as one of the modular accessories in accordance with an embodiment. The rotisserie assembly 100 includes a control knob 102 for controlling heat, and a cook box 104. The cook box 104 includes a door 106 having a window 108. A rotating rotisserie 110 is mounted in the interior of the rotisserie assembly 100. The rotating rotisserie 110 may be powered by battery or electrical power, and in an embodiment is driven by a rotisserie motor that is included with the grill 20. A similar structure may be provided without a rotating rotisserie 110 and may be used as an oven.

For each of the modular accessories that requires a burner, a quick connect gas coupling may be provided so that the modular accessory may be quickly connected to or disconnected from the gas manifold for the grill 20. An example is shown in FIG. 8, where a fixed female connector 120 includes a sliding ring 122. This fixed female connector 120 is mounted, for example, underneath the left side table 38.

If the female connector 120 is used on the grill 20, each of the modular accessories that includes a burner or that otherwise utilizes fuel supplied by the grill 20 includes a male coupling, such as a male coupling 130 shown in FIG. 8. The male coupling 130 includes a shoulder 132. When the male coupling 130 is inserted into the female connector 120, the shoulder 132 fits behind spring-biased ball bearings (not shown, but known) mounted under the sliding ring 122 of the female connector 120. To attach the male coupling 130 to the female connector 120, the male coupling 130 is simply inserted into the female connector 120, which causes the ball bearings to retract, the sliding ring 122 to slide, and permits the shoulder 132 to extend behind the ball bearing in a manner known in the art. The male coupling 130 then clicks into place, and the sliding ring 122 moves forward to extend behind the ball bearings, which hold the shoulder 132 in place. To remove the male coupling 130, the sliding ring 122 is grasped and moved rearward, releasing the ball bearings from behind the shoulder 132, thus permitting release of the male coupling 130.

As stated above, such a connector is known in the art. Preferably, any coupling used with the grill will comply with American National Standards Institute, Inc. (ANSI) and the Canadian Standards Association's (CSA) standard for Outdoor Cooking Gas Appliances, ANSI Z21.58, CSA 1.6, and standard for outdoor cooking specialty gas appliances ANSI Z21.89, CSA 1.18. Alternative coupling mechanisms may also be utilized.

In an alternate embodiment, a fixed male coupling may be provided on the modular assemblies that automatically locks into a female connector, such as the female connector 120, positioned on the grill 20. As part of moving the modular assembly into place, the coupling is automatically locked into position. Then, to remove the modular accessory, the coupling is first disconnected, for example reaching under the modular accessory, or by an extended handle or another mechanism that may permit release of the coupling while grabbing the modular accessory to remove the modular accessory from the grill 20. Other configurations are also possible. For example, the grill 20 may include a female connector having o-rings into which a male nozzle of a modular accessory may slide when the modular accessory is put into place, the o-rings providing a seal between the female connector and the male nozzle. Insulation or other shielding may be used to keep users from burning themselves on the firebox or other parts of the grill 20 when connecting or disconnecting the coupling.

In accordance with an embodiment, the modular accessories discussed herein permit a manufacturer and/or a retailer to accessorize a grill as desired. For example, a grill may be sold with a low end modular accessory, such as the food preparation assembly 60, so as to lower the selling price of the grill and to permit a purchaser to buy a high quality grill without having to pay for accessories. This purchaser may at a later time buy one or more of the modular accessories so as to enhance the features available to the grill 20.

As another alternative, a manufacturer and/or retailer may package a grill, such as the grill 20, with more than one accessory. In addition, a manufacturer may differentiate a grill for one retailer over another by selling a specific modular accessory, such as the rotisserie assembly 100, with grills provided only to a particular retailer. This feature allows differentiation between a grill sold by one retailer and a grill offered by another.

In addition to accessorizing the modular accessories, the modular accessories that are offered with the grill 20 and/or the configuration of the stand 26 may be changed to meet certain price points and/or to differentiate the grill between one retailer and another. This modularity is provided without requiring different tooling for the firebox 22 and a frame for the stand 26. As an example, a low end grill 220 is shown in FIG. 9 that is similar to the grill 20 in FIG. 1, but includes a less expensive shelf structure 222 underneath the firebox 22 as a replacement for the center and side doors 28, 30 and 32. In addition, the grill 220 includes three control knobs 224, wherein the grill 20 in FIG. 1 has four. The number of control knobs for each of these grills 20, 220 may correspond to the number of burners and/or number of modular accessories that may be used at once with the grill 20.

For each of the grills 20, 220, there are a number of common features that do not require molding of separate parts. For example, the firebox 22, the right and left side tables 36, 38, and a frame for the stand 26 are all common. Thus, these parts may be used for multiple grills, reducing the expense of channel differentiation and parts storage.

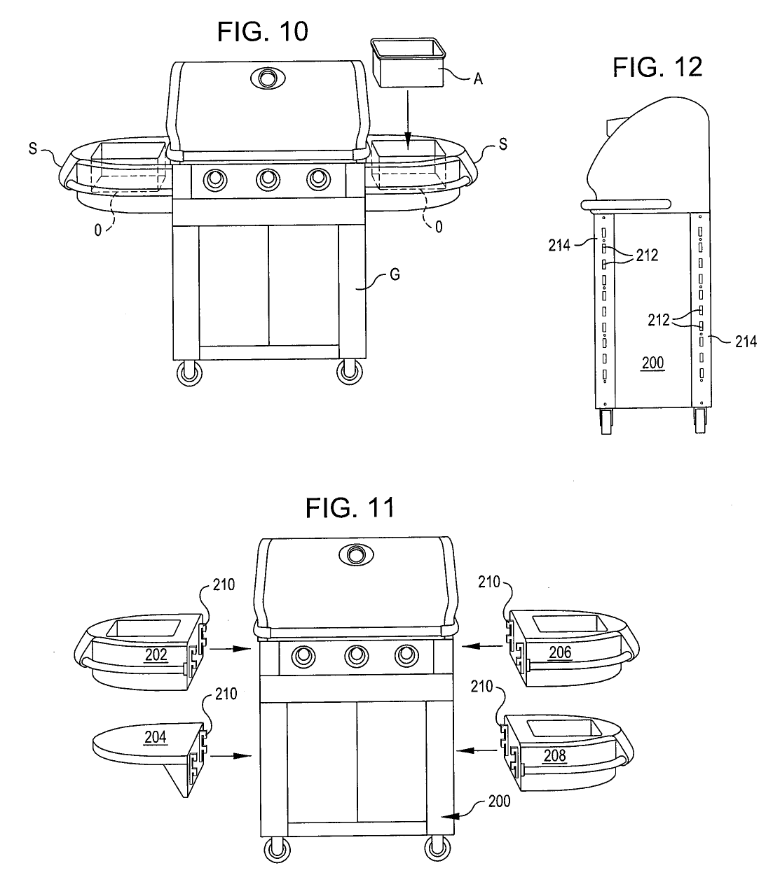

In the embodiments described thus far, the various side accessories or cooking accessories are “drop-in” types of solutions. That is, as can be seen in FIG. 10, a grill G includes side tables S having openings O into which accessories A may be inserted. In alternate embodiments, cooking accessories may be attached to a grill in different ways. As examples, an accessory may be clamped, hooked, clipped, connected magnetically, or otherwise attached to a grill. As an example, as shown in FIG. 11, a grill 200 includes removable side accessories 202, 204, 206, and 208. These side accessories 202, 204, 206, and 208 include brackets 210 that fit into slots 212 (FIG. 12) on vertical rails 214. If needed, a separate quick connect gas connection may be provided for one or more of the accessories 202, 204, 206, 208.

The accessories 202, 204, 206, 208 easily clip onto the vertical rails 214 via the brackets 210. In addition, if additional slots 212 are provided, such as in the embodiment shown in FIG. 12, one or more accessories not in use may be stored underneath an accessory that is at a use level. Similar rails may be provided on the back, front, or underneath a firebox for storage of accessories. Moreover, the rails 214 allow accessories to be height adjustable for particular applications. As an example, a user may want to use a rotisserie at a lower level than a hot dog cooker.

In addition, if desired, one or more of the accessories 202, 204, 206, 208 may be usable at a lower storage position and while under another accessory. For example, one of the accessories, such as the accessory 208, may serve as food storage or as an insulated container for holding beverages. As such, the accessory 208 may be used at the lower level, for example to store food just prior to the food being put on the grill.

The grills described herein with the removable accessories provide quite a bit of flexibility for a user. With an adequate number of side accessories, a user may cook an entire meal at a grill, without having to run back and forth between the grill and a kitchen.

The modular accessories may be used with other free standing devices. As an example, a free standing sink may be provided that includes vertical rails such as the vertical rails 214.

Other variations are within the spirit of the present invention. Thus, while the invention is susceptible to various modifications and alternative constructions, a certain illustrated embodiment thereof is shown in the drawings and has been described above in detail. It should be understood, however, that there is no intention to limit the invention to the specific form or forms disclosed, but on the contrary, the intention is to cover all modifications, alternative constructions, and equivalents falling within the spirit and scope of the invention, as defined in the appended claims.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A grill comprising:
a firebox;
a stand for supporting the firebox; and
a first structure, connected to at least one of the stand and the firebox, and configured to connect to a second structure available on multiple interchangeable accessories.

2. The grill of claim 1, wherein the accessories are cooking accessories, and further comprising a coupling for providing at least one of a fuel source, electric power, water, or mechanical motion to a cooking accessory attached to the grill.

3. The grill of claim 2, wherein the coupling is releasable.

4. The grill of claim 2, wherein the cooking accessories are a subset of a hot dog cooker, a steamer, a food preparation assembly, a side burner, a griddle, a skillet, a deep fryer, an oven, and a rotisserie.

5. The grill of claim 2, further comprising a motor for powering a cooking accessory connected to the structure.

6. The grill of claim 1, wherein the first structure comprises at least one of an opening, an inset, or a rail.

7. The grill of claim 1, wherein the structure comprises an inset into which an accessory is received, the second structure of the accessory comprising a surface that fits into the inset.

8. The grill of claim 7, wherein the inset is configured such that the accessory is held in place by gravity.

9. The grill of claim 1, wherein the first structure comprises at least one rail having multiple attachment locations such that an accessory may be attached at multiple different locations.

10. The grill of claim 9, wherein said at least one rail is arranged vertically.

11. The grill of claim 10, wherein said at least one rail is configured so that two accessories may be connected to said at least one rail with one accessory above the other accessory.

12. The grill of claim 1, further comprising a third structure, connected to at least one of the stand and the firebox, and configured to connect to the second structure.

13. A grill, comprising:
a cooking grate;
a burner under the grate;
a fuel conduit for providing fuel to the burner;
at least one of a opening, an inset, a rail, or a coupling for receiving at least one of many interchangeable cooking accessories, the opening, inset, rail, or coupling positioned approximately on the same level as the cooking grate; and
a releasable coupling for connecting at least one of said many interchangeable cooking accessories to the fuel conduit.

14. The grill of claim 13, wherein the cooking accessories comprise a subset of a hot dog cooker, a steamer, a food preparation assembly, a side burner, a griddle, a skillet, a deep fryer, an oven, and a rotisserie.

15. The grill of claim 13, further comprising a structure for holding cooking accessories in a storage position.

16. The grill of claim 15, wherein the structure is arranged so that the storage position is below the cooking grate.

17. A method for selling grills, comprising:
offering grills for sale, the grills being configured to interchangeably receive modular accessories at a single position on the grill, the modular cooking accessories comprising a subset of a hot dog cooker, a steamer, a food preparation assembly, a side burner, a griddle, a skillet, a deep fryer, a rotisserie, an oven, an insulated beverage container, a storage drawer, a refrigerator, a mini-keg cooler, an extended table, and a light; and
offering a subset of the modular cooking accessories for sale separate from the grill.

18. The method of claim 17, wherein offering grills for sale comprises providing at least one modular cooking accessory with each grill.

19. The method of claim 18, wherein offering at least one modular cooking accessory for sale with each grill comprises:
offering for sale at least one grill with a first modular cooking accessory, the grill and first modular cooking accessory comprising a combination, to a first merchandiser; and
offering for sale said at least one grill with a modular cooking accessory different than the first modular cooking accessory to a second merchandiser.

20. The method of claim 19, wherein offering for sale said at least one grill with the first modular cooking accessory to the first merchandiser comprises offering for sale said at least one grill with the first modular cooking accessory exclusively to the first merchandiser.
